(19) United States
(12) Patent Application Publication
(10) Pub. No.: US 2022/0102735 A1
(43) Pub. Date: Mar. 31, 2022

(54) NANOCARBON MATERIAL AGGREGATE AND CATALYST FOR ELECTROCHEMICAL REACTION COMPRISING SAME

(71) Applicant: NEC Corporation, Minato-ku, Tokyo (JP)

(72) Inventors: Kazuki IHARA, Tokyo (JP); Takashi MANAKO, Tokyo (JP); Ryota YUGE, Tokyo (JP)

(73) Assignee: NEC Corporation, Minato-ku, Tokyo (JP)

(21) Appl. No.: 17/426,115

(22) PCT Filed: Jan. 27, 2020
(86) PCT No.: PCT/JP2020/002807

§ 371 Date: Jul. 28, 2021

(30) Foreign Application Priority Data
Jan. 28, 2019 (JP) 2019-012024

(51) Int. Cl. H01M 4/90; C01B 32/18

(52) U.S. Cl. CPC H01M 4/9083; C01P 2004/64; C01B 32/18

(57) ABSTRACT

A nanocarbon material aggregate excellent as a catalyst in an electrochemical reaction can be provided. The present invention relates to a nanocarbon material aggregate, comprising: a fibrous carbon nanohorn aggregate constituted by a plurality of carbon nanohorns including a carbon nanohorn having a hole-opening; and a first particle encapsulated in the carbon nanohorn having a hole-opening and partially exposed to the outside from the carbon nanohorn.

### TECHNICAL FIELD

The present invention relates to a nanocarbon material aggregate, a catalyst for electrochemical reaction comprising the same, and manufacturing methods thereof.

### BACKGROUND ART

In fuel cells utilizing electrochemical reaction systems and the like, metallic fine particles arranged on the surface of a support such as carbon are used as a catalyst. To date, enhancement of characteristics of the catalyst by miniaturization of the metallic fine particles, improvement of the specific surface area of the support, and improvement of the electrical conductivity of the support and the like have widely been attempted. For example, Patent Literature 1 describes a catalyst for fuel cell cathodes containing alloy fine particles in which a plurality of metals are used as an alloy.

In recent years, nanocarbon materials such as carbon nanotubes, graphenes, and carbon nanohorn aggregates have been gaining attention as a high quality industrial catalyst support, due to their large specific surface area and high electrical conductivity. For example, Patent Literature 2 describes a fuel cell catalyst in which holes are opened on the surface of carbon nanohorn aggregates and metallic fine particles as a catalyst are supported. The carbon nanohorn aggregate described in Patent Literature 2 is an aggregate in which many carbon nanohorns are aggregated in a spherical form.

### CITATION LIST

### Patent Literature

Patent Literature 1: Japanese Patent Laid-Open Publication No. 2004-253385

Patent Literature 2: Japanese Patent Laid-Open Publication No. 2009-190928

### SUMMARY OF INVENTION

### Technical Problem

However, development of a catalyst having a further higher activity than the catalysts described in Patent Literature 1 and Patent Literature 2 has been required.

### Solution to Problem

One aspect of the present embodiment relates to

a nanocarbon material aggregate, comprising:

a fibrous carbon nanohorn aggregate constituted by a plurality of carbon nanohorns comprising a carbon nanohorn having a hole-opening; and

a first particle encapsulated in the carbon nanohorn having a hole-opening and partially exposed to the outside from the carbon nanohorn.

According to one aspect of the present embodiment, a nanocarbon material aggregate excellent as a catalyst in an electrochemical reaction can be provided by convenient manufacturing methods.

### BRIEF DESCRIPTION OF THE DRAWINGS

FIG. 1 is a schematic diagram showing the shape of a fibrous carbon nanohorn aggregate.

FIG. 2 is a scanning transmission electron microscopic image of a fibrous carbon nanohorn aggregate and a spherical carbon nanohorn aggregate.

FIG. 3 is a Z contrast image of a fibrous carbon nanohorn aggregate.

FIG. 4 is a schematic diagram showing the structure of the tip end of a carbon nanohorn.

FIG. 5(a) to (c) are schematic diagrams showing the structures of the carbon nanohorns (a) before oxidation treatment, (b) after oxidation treatment, and (c) after supporting the catalyst, in the manufacture of a nanocarbon material aggregate.

### DESCRIPTION OF EMBODIMENTS

Hereinafter, the nanocarbon material aggregate of the present embodiment will be described.

One aspect of the nanocarbon material aggregate of the present embodiment comprises a fibrous carbon nanohorn aggregate constituted by a plurality of carbon nanohorns including a carbon nanohorn having a hole-opening, and a first particle encapsulated in the carbon nanohorn having a hole-opening and partially exposed to the outside from the carbon nanohorn.

### (Fibrous Carbon Nanohorn Aggregate)

The fibrous carbon nanohorn aggregate constituting the nanocarbon material aggregate of the present embodiment will be described.

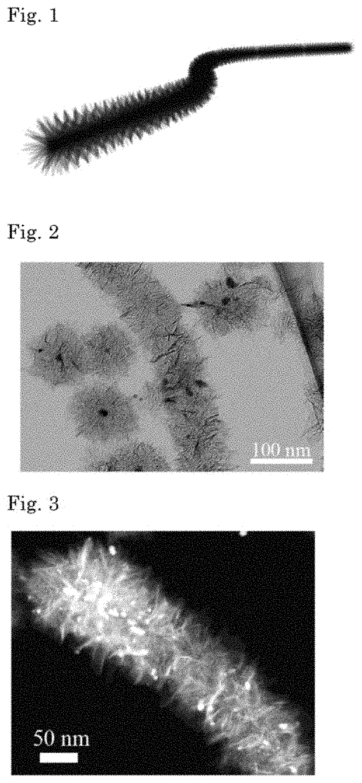

The fibrous carbon nanohorn aggregate is also called a carbon nanobrush (CNB), and has a structure in which a plurality of carbon nanohorns are radially aggregated and fibrously connected. From its appearance, this structure resembles a brush for test tubes or a chenille (mall) in shape. FIG. 1 is a schematic diagram of the shape of the fibrous carbon nanohorn aggregate. The fibrous carbon nanohorn aggregate is different from a material in which a plurality of carbon nanohorns simply range and which looks fibrous, and can retain the fibrous shape even when being subjected to an operation such as centrifugation or ultrasonic dispersion. The carbon nanohorn is a conical-shape carbon structural body, in which a graphene sheet is rolled whose tip is hornily sharpened to a tip angle of about 20°. The fibrous carbon nanohorn aggregate is usually formed by seed-type, bud-type, dahlia-type, petal dahlia-type or petal-type (graphene sheet structure) carbon nanohorn aggregates being connected. That is, the fibrous carbon nanohorn aggregate contains one type or plural types of these carbon nanohorn aggregates in the fibrous structure. The seed-type has such a shape that the surface of the aggregate has few or no horny protrusions; the bud-type has such a shape that the surface of the aggregate has a few horny protrusions; the dahlia-type has such a shape that the surface of the aggregate has a large number of horny protrusions; and the petal-type has such a shape that the surface of the aggregate has petal-like protrusions. The petal structure is a structure of 2 to 30 sheets of graphene of 50 nm to 200 nm in width and 0.34 nm to 10 nm in thickness. The petal dahlia-type is a structure intermediate between the dahlia-type and the petal-type. The fibrous carbon nanohorn aggregate is not limited to the above structure as long as the carbon nanohorns are aggregated in a fibrous form. The fibrous carbon nanohorn aggregate is described in International Publication No. WO2016/147909, and the disclosure of this document is incorporated and described in the present specification by reference.

The nanocarbon material aggregate of the present embodiment may include not only the fibrous carbon nanohorn aggregate, but also spherical carbon nanohorn aggregates. As described below, typically when fibrous carbon nanohorn aggregates are manufactured, spherical carbon nanohorn aggregates are manufactured at the same time. FIG. 2 is a scanning transmission electron microscopic (STEM) photograph of a fibrous carbon nanohorn aggregate and a spherical carbon nanohorn aggregate. In the spherical carbon nanohorn aggregate, seed-shaped, bud-shaped, dahlia-shaped, petal dahlia-shaped, or petal-shaped (graphene sheet structure) carbon nanohorn aggregates, alone or in combination, form a spherical structure (it does not necessarily mean a regular sphere, it may have other shapes such as elliptical shape and donut shape). The form and particle diameter of the carbon nanohorn aggregates to be produced may vary depending on the type and flow rate of gas. As used herein, the fibrous carbon nanohorn aggregate and the spherical carbon nanohorn aggregate may be simply described as the “carbon nanohorn aggregate” or the “aggregate”. The fibrous carbon nanohorn aggregate and the spherical carbon nanohorn aggregate can be separated by differences in size. Further, when impurities other than the carbon nanohorn aggregates are included, they can be removed using centrifugation, differences in sedimentation rate, size-based separation, and the like. Changing the production conditions enables changing the ratio between the fibrous carbon nanohorn aggregate and the spherical carbon nanohorn aggregate.

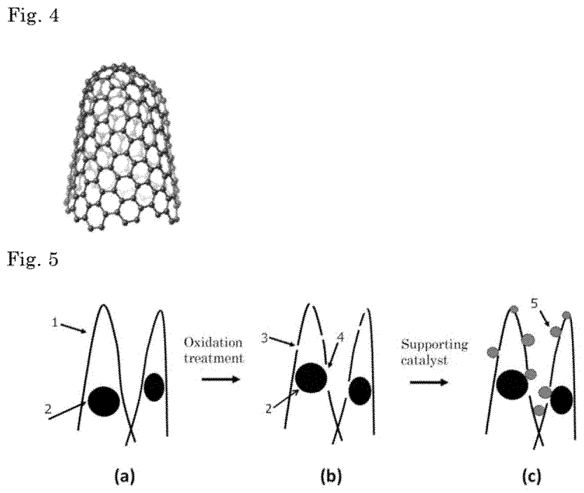

A carbon nanohorn (a single carbon nanohorn) constituting the fibrous carbon nanohorn aggregate and the spherical carbon nanohorn aggregate does not have a cylindrical structure with a uniform tube diameter like a carbon nanotube, but is a carbon structure having a cylinder structure which has a hollow cone (that is, horn)-shaped tip part with different tube diameters. FIG. 4 is a schematic diagram of the tip part of a carbon nanohorn. Typically, cylindrical carbon nanotubes are covered with a graphite structure of 6-membered rings, and 5-membered rings or 7-membered rings are continuously mixed within these 6-membered rings, so that the diameter of individual tubes becomes narrower or wider, and thereby the diameter changes. The cone-shaped carbon nanohorn in the present embodiment has a structure in which the diameter of the horn is continuously changed by mixing 5-membered rings and 7-membered rings in this 6-membered ring structure. The carbon structure of this carbon nanohorn may be a single layer or multi layers, and is preferably a single layer.

The diameter of each carbon nanohorn (single) included in the fibrous carbon nanohorn aggregate and the spherical carbon nanohorn aggregate is approximately 1 nm to 20 nm, and the length thereof is 30 nm to 100 nm. The fibrous carbon nanohorn aggregate has a diameter of about 30 nm to 200 nm, and a length of about 1 μm to 100 μm. The aspect ratio (length/diameter) of the fibrous carbon nanohorn aggregate is typically 4 to 4,000, and for example, 5 to 3,500. The spherical carbon nanohorn aggregate has a diameter of about 30 nm to 200 nm and an almost uniform size.

In the carbon nanohorn constituting the fibrous carbon nanohorn aggregate in the present embodiment, one end serving as the tip end may be closed or opened. The cone-shaped vertex of the one end may be terminated in the rounded shape. When the cone-shaped vertex of the one end is terminated in the rounded shape, the carbon nanohorns are radially aggregated with the part where the vertex is rounded facing outward. Further, the fibrous carbon nanohorn aggregate may include carbon nanotubes.

The fibrous carbon nanohorn aggregate is characterized by a structure with a long conductive path in which carbon nanohorns having a high conductivity are connected in a fibrous shape, and thus has a high conductivity. Further, the fibrous carbon nanohorn aggregate also has a high dispersibility, resulting in a high effect of imparting conductivity.

The fibrous carbon nanohorn aggregate is fabricated by evaporating a target containing a catalyst for synthesis and carbon, as described below. Inside the carbon nanohorns constituting the fibrous carbon nanohorn aggregate, particles of the catalyst for synthesis and the like used in the fabrication are encapsulated (it is the catalyst for synthesis in which black particles in the STEM photograph of FIG. 2 and white particles in the Z contrast image of FIG. 3 are encapsulated).

FIG. 5(a) is a schematic diagram showing one aspect of the structure of the fibrous carbon nanohorn aggregate (before oxidation treatment). In FIG. 5(a), a tip part 1 of a carbon nanohorn has an angular shape, and a particle 2 of the catalyst for synthesis and the like is encapsulated inside the wall constituted by a carbon single layer. The fibrous carbon nanohorn aggregate constitutes a structure in which carbon nanohorns are radially combined and connected with their angular tip parts facing outward, so that the outer space and the inner space are substantially isolated from each other. In the inner space of such a carbon nanohorn aggregate, metals of the catalyst for synthesis and the like used for synthesizing the fibrous carbon nanohorn aggregate are present. The particle of the catalyst for synthesis and the like may be present inside the single carbon nanohorn as in FIG. 5(a), or catalytic metals may be fused to become large and may move in the direction toward the center of the fibers.

Similarly, the particle of the catalyst for synthesis and the like are also encapsulated inside the carbon nanohorn constituting the spherical carbon nanohorn aggregate manufactured together with the fibrous carbon nanohorn aggregate.

The fibrous carbon nanohorn aggregate is fabricated as follows: carbon containing a catalyst for synthesis is used as a target (called a catalyst-containing carbon target for synthesis), and the catalyst-containing carbon target is heated by laser ablation in a nitrogen, inert or mixed atmosphere under rotation of the target in a chamber where the target is disposed, to thereby vaporize the target. In the course of the vaporized carbon and catalyst being cooled, the fibrous carbon nanohorn aggregate and the spherical carbon nanohorn aggregate are obtained. As a method for fabricating the fibrous carbon nanohorn aggregate, other than the above laser ablation method, an arc discharge method or resistance heating method can be used. However, the laser ablation method is more preferable from the viewpoint of being capable of continuous production at room temperature and at the atmospheric pressure.

The laser ablation (LA) method applied is a method in which the target is irradiated with laser continuously or in pulses, and when the irradiation intensity reaches a value equal to or higher than a threshold, the target converts energy, resulting in production of plumes, and the product is guided to deposit on the substrate provided downstream of the target, or to be suspended in a space in the apparatus and recovered in the recovery room.

The laser ablation can use a CO₂ laser, a YAG laser, an excimer laser, a semiconductor laser or the like, and a CO₂ laser, which is easy in output raising, is most suitable. The CO₂ laser can be used at an output of 1 kW/cm² to 1,000 kW/cm², and can carry out continuous irradiation and pulsed irradiation. For production of the fibrous carbon nanohorn aggregate, the continuous irradiation is more desirable. Laser beams are condensed by a ZnSe lens or the like and irradiated. The aggregate can be synthesized continuously by rotating the target. The rotational speed of the target may be set optionally, but 0.1 to 6 rpm is especially preferable. At 0.1 rpm or more, graphitization can be suppressed; and at 6 rpm or less, the increase of amorphous carbon can be suppressed. At the time, the laser output is preferably 15 kW/cm² or more, and most effectively 30 to 300 kW/cm². When the laser output is 15 kW/cm² or more, the target is suitably vaporized and the synthesis is made easy. When the laser output is 300 kW/cm² or less, the increase of the amorphous carbon can be suppressed. The pressure in the chamber can be used at 13,332.2 hPa (10,000 Torr) or lower, but the closer to vacuum the pressure, the production of carbon nanotubes is made easier, resulting in making it difficult for the carbon nanohorn aggregate to be obtained. The pressure in using is preferably 666.61 hPa (500 Torr) to 1,266.56 hPa (950 Torr), and more preferably nearly the atmospheric pressure (1,013 hPa (1 atm≅760 Torr), which is suitable also for mass synthesis and cost reduction. The irradiation area can be controlled by the laser output and the extent of light condensing by the lens, and 0.005 cm² to 1 cm² can be used.

The catalyst for synthesis used for manufacturing the fibrous carbon nanohorn aggregate may be any materials which can synthesize the carbon nanohorn aggregate, but metals such as transition metals are preferred, and at least one selected from the group consisting of Fe, Cu, Co, Ni, Au, Pt, Ag, Pd, Ru, and Ti is preferred, or it may be an alloy obtained by combining two kinds or more of them. It is more preferably at least one selected from the group consisting of Fe, Co, and Ni. The concentration of the catalyst may be appropriately selected, and is preferably 0.1% by mass to 10% by mass, and more preferably 0.5% by mass to 5% by mass with respect to carbon. With the concentration of 0.1% by mass or more, the production of the fibrous carbon nanohorn aggregate is ensured. With the concentration of 10% by mass or less, the increase in the target cost can be suppressed.

The temperature in the chamber used for manufacturing the fibrous carbon nanohorn aggregate is not particularly limited, and is preferably 0 to 100° C., and more preferably, it is appropriate to be used at room temperature for mass synthesis and cost reduction.

Into the container, a nitrogen gas, an inert gas and the like are introduced alone or in combination, to make the above atmosphere. The gas is circulated in the reaction chamber and produced substances can be recovered by the flow of the gas. A closed atmosphere may be made by the introduced gas. The flow rate of atmospheric gas used may be optional, but is preferably in a range of 0.5 L/min to 100 L/min. The gas flow rate is controlled to be constant during the process of evaporating the target. Keeping a constant gas flow rate can be performed by balancing the supply gas flow rate and the exhaust gas flow rate. When performing around ordinary pressure, it can be performed by pushing and exhausting the gas in the chamber by supply gas.

The catalyst for synthesis may be encapsulated in the carbon nanohorn constituting the fibrous carbon nanohorn aggregate during the synthesis process of the fibrous carbon nanohorn aggregate. In addition, when metals other than the catalyst for synthesis and/or non-metallic materials such as magnetic materials are mixed into the target in the synthesis of the fibrous carbon nanohorn aggregate, particles derived from materials other than the catalyst for synthesis may be encapsulated in the carbon nanohorn. As used herein, the particle encapsulated inside the carbon nanohorn may be described as “the catalyst for synthesis and the like” or “the particle of the catalyst for synthesis and the like”. The diameter of the particle encapsulated in the carbon nanohorn is preferably less than 50 nm, more preferably 20 nm or less, and still preferably 10 nm or less, and the lower limit is, without particular limitation, larger than 0.7 nm, more preferably 1 nm or more, still preferably larger than 3 nm, and still more preferably 5 nm or more.

### (Opening Treatment of Carbon Nanohorn Aggregate)

In the present embodiment, a hole-opening is formed on the carbon surface of the carbon nanohorn constituting the fibrous carbon nanohorn aggregate by subjecting the above fibrous carbon nanohorn aggregate to oxidation treatment and the like. When a hole-opening is formed in a carbon nanohorn encapsulating a particle of the catalyst for synthesis and the like, the particle encapsulated in the carbon nanohorn is partially exposed to the outside of the carbon nanohorn from this hole-opening. As used herein, the particle encapsulated in a carbon nanohorn having a hole-opening and partially exposed to the outside from the hole-opening is referred to as the “first particle”. Hereinafter, the details will be described.

The fibrous or spherical carbon nanohorn aggregate produced by the above laser ablation and the like has no or few surface functional groups, and thus it is hydrophobic. This carbon nanohorn aggregate is subjected to treatment with an oxidizing acid or oxidation treatment by heat treatment under a gas atmosphere to introduce a functional group, so that a hole can be formed on the carbon surface of the carbon nanohorns. Examples of the oxidizing acid include sulfuric acid, nitric acid, a mixed solution of sulfuric acid-nitric acid, hydrogen peroxide, and chloric acid. The oxidation treatment by these acids is performed in a liquid phase, and it is performed at about 0° C. to 180° C. (the temperature may be a temperature at which an aqueous solution is present as a liquid) in the case of an aqueous system and at a temperature at which a solvent is present as a liquid in the case of an organic solvent system. This enables addition of hydrophilic functional groups such as carbonyl group, carboxyl group, hydroxyl group, ether group, imino group, nitro group, and sulfone group to 5-membered rings, 7-membered rings, or other carbon sites having a high reactivity, positioned on the curved graphite surface such as the tip end and side surface of the carbon nanohorns, and formation of the hole-opening. For example, a hole can be formed on the carbon surface of the fibrous carbon nanohorn aggregate by heating at a temperature range of room temperature to 80° C. in hydrogen peroxide water, it is preferably treated at 20° C. to 80° C., and in particular, it is desirably heated at a temperature range of 50 to 80° C. The size of the hole can be adjusted by controlling the temperature within the above range and the treatment time. The treatment time may be appropriately adjusted, and is preferably changed within a range of about 0.5 hours to 3 hours.

When the oxidation treatment is performed by heat treatment under a gas atmosphere, it can be performed in air, oxygen, or carbon monoxide, and is desirably performed in an air atmosphere for cost reduction. The heat treatment temperature at this time is preferably in a range of 250 to 600° C.

As a result of the above oxidation treatment, the hole-opening is formed on the carbon surface of the carbon nanohorn constituting the fibrous carbon nanohorn aggregate. The nanocarbon material aggregate of the present embodiment includes the carbon nanohorn encapsulating the particle (catalyst for synthesis and the like), and this particle is partially exposed to the outside of the carbon nanohorn from the hole-opening formed on the carbon surface of the carbon nanohorn.

In one aspect of the present embodiment, as the hole-opening, a first hole allowing a particle having a particle diameter of 0.7 nm to pass through, and a second hole not allowing a particle having a particle diameter of 0.7 nm to pass through are formed on the surface of the carbon nanohorn by oxidation treatment and the like.

The first hole which is a relatively large hole-opening is likely to be formed on the carbon surface proximate to the encapsulated particle (catalyst for synthesis and the like) in the carbon nanohorn constituting the fibrous carbon nanohorn aggregate. This is considered because interactions between the encapsulated particle and carbon enhance the oxidation reaction, resulting in formation of a large hole. For example, the particle of the catalyst for synthesis and the like represented by iron enhances the oxidation reaction of the neighboring carbon in the hydrogen peroxide water by using the particle itself as a catalyst. As a result, the hole-opening is rapidly extended as compared with the second hole described below in the carbon surface, so that a large hole which partially exposes the encapsulated particle is formed. That is, the first particle is partially exposed to the outside of the carbon nanohorn mainly from the first hole. The first particle may be partially emerged from the first hole, or the first hole may be separated from the first particle. As described above, it is preferable that the first hole be formed in the neighboring of the first particle, and for example, the distance between the first particle and the first hole proximate to each other (the minimum distance) be the particle diameter of the first particle or shorter.

FIG. 5(b) is a schematic diagram of the carbon nanohorns on which hole-openings are formed by oxidation treatment. A first hole 4 is formed in the neighboring of the first particle 2, and the first particle 2 is partially exposed to the outside from the first hole 4. Further, a second hole 3, which is smaller than the first hole 4, is formed apart from the first particle 2.

The size of the first hole is preferably in a range which allows the particle having a particle diameter of 0.7 nm to pass through while keeping the first particle encapsulated, and for example, the diameter (the diameter of the maximum inscribed circle internally contacting the inner periphery of the hole-opening) is preferably 0.7 nm or more and less than 50 nm, more preferably 0.7 nm or more and less than 20 nm, and still preferably 3 nm or more and 10 nm or less. The size of the first hole can be adjusted by changing the oxidation treatment conditions.

The first particle is suitably a metal used as the catalyst for synthesis of the fibrous carbon nanohorn aggregate, and in addition to that, it may contain other metal particles mixed into the target, alloy particles, inorganic material particles including magnetic material particles, or two or more different particles obtained by combining them. The particle can be arranged on a different position (for example, the horn tip part or bottom part of the carbon nanohorn) by changing the diameter distribution of the first particle.

In one aspect of the nanocarbon material aggregate, when the first particle is a material used as a catalyst of the electrochemical reaction, for example, transition metals such as Fe, Cu, Co, Ni, Au, Pt, Ag, Pd, Ru, and Ti, it can exhibit the effect as the catalyst for electrochemical reaction on the metal surface exposed to the outside of the carbon nanohorn, which can be used as a catalyst for fuel cells and the like. When a material having a deodorizing effect, for example, metal oxide or sulfate salt is used as the first particle, a nanocarbon material aggregate as a catalyst for exhibiting a deodorizing effect and the like can be obtained from the exposed particle surface.

One or more first holes may be formed on the surface of one carbon nanohorn.

The second hole, which is a relatively small hole-opening, is likely to be formed in the area where a particle of the catalyst for synthesis and the like that is in the internal space proximate to the carbon surface is not present, in the carbon nanohorn constituting the fibrous carbon nanohorn aggregate. The second hole is formed on the carbon surface of, for example, 5-membered ring portions, 7-membered ring portions, or other carbon sites having a high reactivity on the tip part and side surface part of the carbon nanohorn. The size of the second hole is such a size that the particle having a particle diameter of 0.7 nm is not allowed to pass through, and for example, the diameter (the diameter of the maximum inscribed circle internally contacting the inner periphery of the hole-opening) is 0.24 nm or more and less than 0.70 nm, and preferably, a minimum distance d between non-adjacent carbon atoms among the carbon atoms constituting the hole is 0.24 nm or more and less than 0.70 nm.

One or more second holes are formed on the surface of one carbon nanohorn, but typically, a plurality of second holes is substantially uniformly formed on the carbon surface.

In one aspect of the nanocarbon material aggregate of the present embodiment, both the first hole and the second hole are formed on the carbon nanohorn encapsulating the catalyst for synthesis and the like, and only the second hole is formed on the carbon nanohorn encapsulating no catalyst for synthesis and the like. When the nanocarbon material aggregate comprises the spherical carbon nanohorn aggregate, the first hole and/or the second hole are/is formed also in the carbon nanohorn constituting the spherical carbon nanohorn aggregate by oxidation treatment and the like.

The nanocarbon material aggregate of the present embodiment can be used as a catalyst for electrochemical reaction by exposing the first particle from the hole-opening, without separately supporting catalyst metal particles. Since the nanocarbon material aggregate of the present embodiment comprises the fibrous carbon nanohorn aggregate, it has a high conductivity as compared with the nanocarbon material aggregate consisting of the spherical carbon nanohorn aggregate only.

(Support of Second Particles onto Carbon Nanohorn Aggregate)

In one aspect of the present embodiment, nano-sized fine particles (the second particles) of a metal, a metal complex, or a compound containing the metal (such as an oxide) can be topically adsorbed to (supported on) the hole-opening of the carbon surface of the carbon nanohorn. At this time, the particle diameter of the nano-sized fine particles to be adsorbed becomes smaller as the number of the opened holes increases because fine particles are less likely to condense, thereby achieving miniaturization of the second particles. The particle diameter of the second particles is not particularly limited, and for example, when the particle diameter is 3 nm or less, fusion and the like of the second particles are less likely to be caused, and the second particles can be prevented from coarsening. The lower limit of the diameter of the second particles is preferably about the diameter of the second hole, and for example, it is preferably about 0.7 nm. It is preferable that the second particles be supported on the outside of the carbon nanohorn without entering into the carbon nanohorn (that is, without passing through the hole opened in the surface of the carbon nanohorn, and on the periphery of the hole or so as to cover the hole) because the second particles can easily exert the catalytic function.

The second particles are preferably supported on the second hole, and are more preferably supported on both the first hole and the second hole.

The second particles are preferably fine particles of a metal, a metal complex, and a compound containing the metal (such as an oxide), and examples thereof include one or two or more metals selected from the group consisting of Au, Pt, Pd, Ag, Cu, Fe, Ru, Ni, Sn, Co, and a lanthanoid element, a metal complex thereof, and a compound containing the metal (such as an oxide). The second particles thus supported (adsorbed) exhibit an electrochemical catalytic effect on the surface of the fibrous carbon nanohorn aggregate, resulting in a surface-supported catalyst. In the present embodiment, the kind of the metal and the like constituting the first particles and the kind of the metal and the like constituting the second particles may be the same or different to each other.

FIG. 5(c) is a schematic diagram showing that the second particles 5 are adsorbed to (supported on) the first hole and the second hole of the carbon nanohorns subjected to oxidation treatment. Supporting the second particles on the carbon nanohorn enables the exhibition of catalytic functions of both the first particles and the second particles. For example, the first particles and the second particles can exhibit different catalytic functions from each other, or can exhibit a higher catalytic activity.

In one aspect of the present embodiment, it is preferable that the first particles be Fe particles (preferably the particle diameter is 1 nm to 20 nm), and the second particles be Pt fine particles (preferably the particle diameter is 0.7 nm to 3.0 nm).

The nanocarbon material aggregate of the present embodiment can be suitably used as a catalyst for electrochemical reaction, and specifically, it is preferably used as a fuel cell catalyst, a hydrogen absorbing catalyst, and a catalyst for carrying out the adsorption or decomposition of odorous substances.

When the nanocarbon material aggregate of the present embodiment is used as a fuel cell catalyst, the second particles are preferably a transition metal material such as Pt, Au, Ni, Pd, and Ru, having an excellent catalytic ability. When used as a hydrogen absorbing catalyst, the second particles are preferably palladium and the like. When used as a catalyst for carrying out the adsorption or decomposition of odorous substances, the second particles are preferably copper sulfate, copper chloride, and the like.

The second particles are preferentially adsorbed so as to be caught in the first hole and the second hole formed on the surface of the fibrous carbon nanohorn aggregate and fixed. As the method for supporting the second particles, a concentration to dryness method, an impregnation method, a colloidal method, and the like may be appropriately used, but the colloidal method in which size control is easy or the convenient impregnation method is desired. As the colloidal method, the method reported by T. Yoshitake, Y. Shimakawa, S. Kuroshima, H. Kimura, T. Ichihashi, Y. Kubo, D. Kasuya, K. Takahashi, F. Kokai, M. Yudasaka, S. Iijima, Physica 2002, B323, 124. can be used. In the impregnation method, a catalyst can be supported by mixing a solution containing the catalytic metal and the fibrous carbon nanohorn aggregate, dispersing, stirring, followed by gathering with a filter. The supported amount of the substances to be adsorbed can be controlled by adjusting the atmosphere (gas phase, liquid phase) and the conditions (solvent, pH, temperature, etc.) used when the catalyst is supported on the fibrous carbon nanohorn aggregate.

### EXAMPLES

Hereinafter, the present invention will be described in more detail by way of examples, but the present invention is not limited by the examples below.

### Manufacture Example 1: Preparation of Fibrous Carbon Nanohorn Aggregates

A nanocarbon material aggregate including a fibrous carbon nanohorn aggregate was manufactured by CO₂ laser ablation. A columnar catalyst-containing carbon target was continuously irradiated with CO₂ laser light at room temperature (about 23° C.) under a nitrogen atmosphere. At this time, the laser output was adjusted to 3.2 kW and the target rotary speed was adjusted to 1 rpm. Fe was used as the catalyst (5% by mass relative to the carbon target). The nanocarbon material containing soot-like substances thus obtained (referred to as the “Sample 1”) was observed using scanning transmission electron microscopy (STEM). FIG. 2 is a STEM photograph of Sample 1. It was found that a fibrous carbon nanohorn aggregate and spherical carbon nanohorn aggregates were produced. In FIG. 2, black particles are iron catalysts and observed to be incorporated into the carbon nanohorn aggregates. FIG. 3 is a Z contrast image of Sample 1, and white particles are iron. It was found from these observations that the particle diameter of iron is mainly 20 nm or less.

### Manufacture Example 2: Oxidation Treatment of Carbon Nanohorn Aggregates

100 mg of the product of Manufacture Example 1 (Sample 1) was put into 200 mL of hydrogen peroxide water (30% by weight), the temperature of which was adjusted to 50° C. using a water bath while stirring at 300 rpm using a stirrer, followed by heating for 1 hour. After heating, the hydrogen peroxide water was filtered through a 0.2 μm filter and washed twice with pure water. Thereafter, the nanocarbon material on the filter was dried in a vacuum oven at 100° C. for 48 hours. The product after oxidation treatment obtained was used as Sample 2. The specific surface area of the nanocarbon material before and after oxidation treatment was calculated from the nitrogen gas adsorption isotherm by the BET method. The BET specific surface area of the product (Sample 1) before oxidation treatment was 400 m²/g, and the BET specific surface area of the product after oxidation treatment (Sample 2) was 450 m²/g, which was slightly increased. From the observation using a transmission electron microscope (TEM), the presence of hole groups having different diameters in Sample 2 and the exposed catalyst for synthesis (encapsulated metal catalyst) could be observed. Therefore, the holes were found to be opened in such a size that almost no nitrogen gas could permeate.

### Example 3: Evaluation of Catalytic Activity

The catalytic activity was evaluated by electrochemical oxygen reduction reaction measurements. A solution in which the powder prepared in Manufacture Example 2 (Sample 2), a Nafion (Registered trademark) solution, and water were dispersed was manufactured, which was added on a rotating disk electrode serving as the working electrode to fix the sample (Electrode 2). Ag/AgCl was used as the reference electrode and platinum was used as the counter electrode. 0.1 M KOH was used as the electrolyte solution. For comparison, an electrode (Electrode 1) was fabricated using the sample of Manufacture Example 1 before oxidation treatment (Sample 1). As a result of the scanning from 0.1 V to −1.0 Vat 5 mV/s, the start of the reaction of Electrode 2 (−5 A/g @-0.4 V vs. Ag/Ag/C1) was earlier than that of Electrode 1 (−2 A/g @-0.4 V vs. Ag/Ag/C1), and it was found that Sample 2 has a higher catalytic function. This is considered because the catalytic metal (Fe) exposed from the hole-opening of Sample 2 was affected.

### Example 4: Support of Pt Catalyst

The nanocarbon material manufactured in Manufacture Example 2 was used as the catalyst support for fuel cells. 1 g of chloroplatinic acid hydrate was dissolved in water at 70° C., and 2 g of sodium sulfite was added and stirred. The pH was controlled to about 5 with sodium hydroxide, and approximately 1.5 g of Sample 2 manufactured in Manufacture Example 2 was added. 50 mL of 30% hydrogen peroxide was added to adjust the pH to 5. Thereafter, it was cooled to room temperature (about 23° C.), Sample 2 supporting the Pt catalyst was separated by centrifugation, followed by drying at 100° C. Thereafter, Sample 2 was reduced with hydrogen. Sample 2 supporting Pt was subjected to thermogravimetric analysis in oxygen, and it was determined that the supporting ratio was 20% relative to the total weight (Pt-supporting sample 2). As a result of observation using scanning transmission electron microscopic (STEM) images, Pt particle size was about 2 nm and the Pt particles were uniformly supported on the carbon surface. For comparison, Pt was made to be supported on Sample 1 before oxidation treatment in the same manner (Pt-supporting sample 1), and it was determined by thermogravimetric analysis that the supporting ratio was 20%. For further comparison, spherical carbon nanohorn aggregates (including no fibrous carbon nanohorn aggregate) were manufactured by performing CO₂ laser ablation in the same conditions as Manufacture Example 1, except for using a graphite target containing no catalyst. Pt was made to be supported on these spherical carbon nanohorn aggregates by the same method as the above Pt-supporting samples 1 and 2 (Pt-supporting sample 3). It was found by the thermogravimetric analysis that the supporting ratio of Pt-supporting sample 3 was 20% relative to the total weight. The catalytic activity of the Pt catalyst was evaluated by the methanol oxidation reaction in an electrochemical manner. The working electrode was fabricated by adding the samples on a rotating disk electrode, Ag/AgCl was used as the reference electrode, and platinum was used as the counter electrode. The electrolyte solution was prepared to be 1M CH₃OH and 0.5M H2504. The comparison was carried out by the specific activity (A/g-Pt) at 0.5 V vs. RHE (reversible hydrogen electrode) at that time. As a result, it was found that the specific activity of methanol oxidation of Pt-supporting sample 2 (35 A/g-Pt) was increased as compared with that of Pt-supporting sample 1 (25 A/g-Pt) and Pt-supporting sample 3 (20 A/g-Pt). It can be inferred that the specific activity of methanol oxidation of Pt-supporting sample 2 was increased because Pt was made to be supported without aggregating due to having the hole-opening on the surface of the carbon nanohorns and the encapsulated Fe was exposed. The results are shown in Table 1.

TABLE 1

| | Carbon nanohorn aggregate | | | Specific |
|---|---|---|---|---|
| | | Use of Fe | Oxidation | activity |
| | Form | catalyst | treatment | (A/g-Pt) |
| Pt-supporting | fibrous + | used | no | 25 |
| sample 1 | spherical | | | |
| Pt-supporting | fibrous + | used | yes | 35 |
| sample 2 | spherical | | | |
| Pt-supporting | spherical | not used | no | 20 |
| sample 3 | | | | |

The whole or part of the example embodiments disclosed above can be described as, but not limited to, the following supplementary notes.

### (Supplementary Note 1)

A nanocarbon material aggregate, comprising:

a fibrous carbon nanohorn aggregate constituted by a plurality of carbon nanohorns comprising a carbon nanohorn having a hole-opening; and

a first particle encapsulated in the carbon nanohorn having a hole-opening and partially exposed to the outside from the carbon nanohorn.

### (Supplementary Note 2)

The nanocarbon material aggregate according to the supplementary note 1, wherein the hole-opening comprises:

a first hole through which a particle having a particle diameter of 0.7 nm is passable, and

a second hole through which a particle having a particle diameter of 0.7 nm is not passable.

### (Supplementary Note 3)

The nanocarbon material aggregate according to the supplementary note 1 or 2, wherein a second particle is further adsorbed to the hole-opening.

### (Supplementary Note 4)

The nanocarbon material aggregate according to the supplementary note 3, wherein the particle diameter of the second particle is 3 nm or less.

### (Supplementary Note 5)

The nanocarbon material aggregate according to any one of the supplementary notes 1 to 4, wherein the particle diameter of the first particle is 20 nm or less.

### (Supplementary Note 6)

The nanocarbon material aggregate according to any one of the supplementary notes 3 to 5, wherein the second particle is one or two or more metals selected from the group consisting of Au, Pt, Pd, Ag, Cu, Fe, Ru, Ni, Sn, Co, and a lanthanoid element, a metal complex thereof, or a compound containing the metal.

### (Supplementary Note 7)

A catalyst for electrochemical reaction, comprising the nanocarbon material aggregate according to any one of the supplementary notes 1 to 6.

### (Supplementary Note 8)

A method for manufacturing the nanocarbon material aggregate according to any one of the supplementary notes 1 to 6, comprising heating a fibrous carbon nanohorn aggregate in hydrogen peroxide water at a temperature range of 20° C. to 80° C.

This application is based upon and claims the benefit of priority from Japanese patent application No. 2019-012024, filed on Jan. 28, 2019, the disclosure of which is incorporated herein in its entirety.

While the invention has been described with reference to example embodiments (and examples) thereof, the invention is not limited to the above example embodiments (and examples). Various changes that can be understood by those skilled in the art may be made to the configuration and details of the invention within the scope of the present invention.

### EXPLANATION OF REFERENCE

1 Tip of carbon nanohorn
2 Particles such as catalysts for synthesis (first particles)
3 Second hole
4 First hole
5 Second particles

What is claimed is:

1. A nanocarbon material aggregate, comprising:
a fibrous carbon nanohorn aggregate constituted by a plurality of carbon nanohorns comprising a carbon nanohorn having a hole-opening; and
a first particle encapsulated in the carbon nanohorn having a hole-opening and partially exposed to the outside from the carbon nanohorn.

2. The nanocarbon material aggregate according to claim 1, wherein the hole-opening comprises:
a first hole through which a particle having a particle diameter of 0.7 nm is passable, and
a second hole through which a particle having a particle diameter of 0.7 nm is not passable.

3. The nanocarbon material aggregate according to claim 1, wherein a second particle is further adsorbed to the hole-opening.

4. The nanocarbon material aggregate according to claim 3, wherein the particle diameter of the second particle is 3 nm or less.

5. The nanocarbon material aggregate according to claim 1, wherein the particle diameter of the first particle is 20 nm or less.

6. The nanocarbon material aggregate according to claim 3, wherein the second particle is one or two or more metals selected from the group consisting of Au, Pt, Pd, Ag, Cu, Fe, Ru, Ni, Sn, Co, and a lanthanoid element, a metal complex thereof, or a compound containing the metal.

7. A catalyst for electrochemical reaction, comprising the nanocarbon material aggregate according to claim 1.

8. A method for manufacturing the nanocarbon material aggregate according to claim 1, comprising
heating a fibrous carbon nanohorn aggregate in hydrogen peroxide water at a temperature range of 20° C. to 80° C.
